(19) United States
(12) Patent Application Publication
(10) Pub. No.: US 2017/0235887 A1
(43) Pub. Date: Aug. 17, 2017

(54) Cognitive Mapping and Validation of Medical Codes Across Medical Systems

(71) Applicant: International Business Machines Corporation, Armonk, NY (US)

(72) Inventors: James S. Cox, Plano, TX (US); Raman Srinivasan, Plano, TX (US)

(21) Appl. No.: 15/045,944

(22) Filed: Feb. 17, 2016

(51) Int. Cl. G06F 19/00; G06F 17/24; G06F 17/27

(52) U.S. Cl. CPC G06F 19/322; G06F 19/328; G06F 17/2785; G06F 17/241

(57) ABSTRACT

Mechanisms are provided for mapping local medical codes to standardized medical codes. Patient information is received from a source. The patient information comprises at least one local medical code that is local to the source and is not standardized across multiple sources of patient information. Cognitive natural language processing is performed on a context of the at least one local medical code to determine a meaning of the at least one local medical code. A standardized medical code is selected based on the determined meaning and a mapping between the at least one local medical code and the selected standardized medical code is generated. The standardized medical codes are common to a plurality of sources of patient information. The patient information is then processed based on the mapping data structure.

### BACKGROUND

The present application relates generally to an improved data processing apparatus and method and more specifically to mechanisms for performing cognitive mapping and validation of medical codes across medical systems.

The American Recovery and Reinvestment Act of 2009 government mandates that medical practices adopt and demonstrate “meaningful use” of electronic health records (EHRs) in order to maintain their existing Medicaid and Medicare reimbursement levels. In addition, the Act also provides financial incentives for healthcare providers who prove such meaningful use of EHRs. A meaningful use of EHRs is defined by the federal government of the United States of America as using digital medical and health records to improve quality, safety, efficiency, and reduce health disparities, engage patients and family, improve care coordination and population and public heath, and maintain privacy and security of patient health information. The Act also provides penalties for non-compliance with the Act including a reduction in Medicaid reimbursements.

Prior to the Act, many medical practices already implemented computer based electronic medical records (EMRs) for the inherent time saving and efficiency features of such computer based systems. These computer systems are varied and have various capabilities depending on the particular implementation of the hardware and software.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising a processor and a memory, for mapping local medical codes to standardized medical codes. The method comprises receiving, by the data processing system, patient information from a source. The patient information comprises at least one local medical code that is local to the source and is not standardized across multiple sources of patient information. The method further comprises performing, by the data processing system, cognitive natural language processing on a context of the at least one local medical code to determine a meaning of the at least one local medical code. The method also comprises selecting, by the data processing system, a standardized medical code from a plurality of standardized medical codes based on the determined meaning of the at least one local medical code. The plurality of standardized medical codes are common to a plurality of sources of patient information. Moreover, the method comprises generating, by the data processing system, a mapping data structure that maps the at least one local medical code to the selected standardized medical code, and processing, by the data processing system, the patient information from the source based on the mapping data structure.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a block diagram illustrating a cloud computing system for providing software as a service, where a server provides applications and stores data for multiple clients in databases according to one example embodiment of the invention;

FIG. 2 is another perspective of an illustrative cloud computing environment in which aspects of the illustrative embodiments may be implemented;

FIG. 3 is an example diagram illustrating a set of functional abstraction layers provided by a cloud computing environment in accordance with one illustrative embodiment;

FIG. 4 is an example block diagram illustrating the primary operational elements of a patient registry engine having medical code mapping logic in accordance with one illustrative embodiment;

FIG. 5 is a flowchart outlining an example operation for performing medical code mapping in accordance with one illustrative embodiment; and

FIG. 6 is a flowchart outlining an example operation for validating an existing medical code mapping in accordance with one illustrative embodiment.

### DETAILED DESCRIPTION

As mentioned above, many medical practices and sources of medical services utilize their own computing systems and corresponding software to manage their medical practices/services and keep medical records for the patients to which they provide healthcare services. Each of these systems may utilize their own local medical coding scheme for associating medical codes with patients in their electronic medical records (EMRs) for tracking the patient's conditions, treatments, and other medical history information. The medical codes may be used to indicate any medical related information that is codified as potentially applicable to a plurality of patients, e.g., diagnoses, procedures performed/recommended, medications prescribed, medical services provided, lab tests performed, lab test results obtained, etc. There is a vast number of different types of medical information that may be associated with pre-defined medical codes, which are then used as a basis for identification of the corresponding medical information, e.g., a medical code of “L5000” may indicate that the patient is a diabetic patient with an amputation.

Moreover, various programs, such as government sponsored programs, insurance company or provider sponsored programs, and other private and public party organization based programs, have been established for compensating medical personnel for treating patients based on the medical codes associated with their patient medical records. For example, Medicare, Medicaid, medical insurance payment programs, and the like, have all been established and each have their own sets of rules or criteria that are required for a medical doctor or other medical personnel (hereafter assumed to be a “doctor” for ease of explanation) to be compensated for the care that they provide to their patients. Many times, these rules or criteria are based on medical codes associated with the patient in the patient's medical record and the medical codes are specific to the medical coding scheme of that particular program. For example, a doctor, when meeting with the patient and providing medical care, must input the correct medical codes into the patient's medical record in order to obtain adequate compensation for the care provided by the doctor to the patient. Thus, if the doctor wishes to receive compensation for treating a diabetes patient with regard to an amputation, then the correct medical codes for diabetic amputation must be input to the patient medical record and corresponding payment system for reporting to the appropriate program supporter, e.g., insurance company, government regulatory agency, or the like.

Thus, as can be seen from the above, there are a large number of sources of medical information that must be managed in order to optimize the care provided to patients, the compensation given to medical personnel and service providers, as well as perform the necessary record keeping to ensure “meaningful use” of electronic health records (EHRs) under the American Recovery and Reinvestment Act. Each of these sources may utilize their own local medical coding schemes and corresponding medical codes. Therefore, it is a daunting task to compile the information from disparate sources of medical information and combine them into a coherent and consistent electronic medical record (EMR) for the patient since various portions of the medical information may use different medical codes without a clear explanation as to what that medical code represents.

For example, a first system may utilize a medical code EH417 to refer to a particular medical malady, another system may utilize a second medical code FZ63 to represent the same medical malady. However, without an intimate knowledge of the two medical coding schemes, one would not know that these medical codes refer to the same medical malady and instead two different medical codes will be maintained in the patient's EMR without explanation. Similar considerations would apply if the same medical code is used by two different medical coding schemes but represent two different types of medical maladies. Moreover, there may be medical codes in one medical coding scheme for a medical malady, but another medical coding scheme does not have medical codes for that medical malady and thus, a medical code is not present, but textual description may indicate that the medical code should be present.

The illustrative embodiments provide a patient registry engine that obtains patient information from a plurality of sources, e.g., various medical practices of doctors, specialists, labs, hospitals, as well as other providers of services and payment associated with the medical field, e.g., medical insurance companies, government organizations, and the like. Each of these sources of medical information may utilize their own local medical code schemes that have meaning within the context of the source, but whose meaning is hard to discern outside of the source since it does not match any standardized medical codes.

The illustrative embodiments further provide a medical code mapping rules repository which may comprise rules for mapping medical codes of a particular source to a standardized set of medical codes. A separate medical code mapping rules repository may be established for each source of medical information. When a patient's medical information is received from a source, the medical code mapping rules repository (or “mapping repository” hereafter) for that source is consulted to map any instances of local medical codes in the medical information received from the source to a standardized medical code instances. That is, for the local medical code instance, the source's mapping repository is consulted to determine if there is an existing medical code mapping that maps the local medical code instance to one or more standardized medical codes. If the mapping exists, then the instance of the local medical code is replaced with the one or more standardized medical codes and/or an annotation is provided in the electronic medical record information to indicate that the mapping has occurred.

If such a mapping does not exist, or the mapping has potentially expired, then a natural language processing operation is employed, using cognitive systems such as the IBM Watson™ cognitive system available from International Business Machines (IBM) Corporation of Armonk, N.Y., to analyze the context of the local medical code as well as other descriptive text from a corpus of other documents from the same source of the medical information and/or a plurality of other sources of medical information, and determine a potential meaning of the medical code. This meaning is then matched to definitions of standardized medical codes in the standardized medical coding scheme. The matching may also utilize cognitive systems and natural language processing to determine the most likely match of the local medical code to one or more predefined standardized medical codes in the standardized medical coding scheme. If the confidence level of the mapping is high enough, the mapping may be performed automatically and the corresponding mapping rule is stored in the mapping repository for future use.

If the confidence level is not high enough (measured according to a threshold), then human confirmation of the mapping may be solicited by providing a suggestion to a subject matter expert as to the mapping and having the subject matter expert (SME) confirm/reject the mapping or provide an alternative mapping of the local medical code to one or more of the standardized medical codes. If the SME confirms the mapping, then it is added to the mapping repository for the source. If the SME provides an alternative mapping, then the alternative mapping is added to the mapping repository for the source. If the SME rejects the mapping, and does not provide an alternative mapping, then no modification of the mapping repository is performed.

In some illustrative embodiments, these mechanisms may also be used to validate existing mappings in the mapping repository for the source as well. That is, in some illustrative embodiments, a periodic validation operation may be performed based on a triggering event. For example, the triggering event may be the expiration of a mapping rule in the mapping repository. That is, each mapping rule may have a timestamp or expiration time attribute which may be compared to current timestamp information to determine if the corresponding mapping rule has expired. Such expiration ensures that the most up-to-date medical codes and corresponding mappings are being utilized since such medical coding schemes may change over time. If the mapping rule has expired, then a validation operation may be triggered. Other triggering events may include a user specifically requesting that mapping rules be validate, an error event occurring that indicates that a validation of the mapping rules should be performed, or the like.

In order to perform the validation, the above analysis performed in the case that no mapping exists in the mapping repository for the source is performed regardless of whether there is a mapping present in the mapping repository. In this way, a candidate mapping rule of the local medical code to one or more standardized medical codes is generated. This candidate mapping rule may then be compared to the actual existing mapping rule in the mapping repository to see if there is a match. If there is a match, i.e. for the local medical code, the same one or more standardized medical codes are indicated by both the existing mapping rule and the candidate mapping rule, then the existing mapping rule is validated in the mapping repository and its corresponding timestamp/expiration time is updated to reflect the validation. If not, then the existing mapping rule may need to be re-evaluated by a human SME. A corresponding notification may be sent to the human SME to request that they either manually validate the existing mapping rule by responding to the notification electronically, provide an alternative mapping rule for the local medical code which is then used to replace the existing mapping rule, or invalidate the existing mapping rule by deleting it from the mapping repository or otherwise marking it as invalid, in which case it will be considered to be essentially not present in the mapping repository and a candidate for overwriting at a later time.

Thus, the mechanisms of the illustrative embodiments provide functionality for mapping local medical codes in medical information obtained from various sources, using their own local medical coding schemes, to a standardized medical coding scheme. The mechanisms of the illustrative embodiments may utilize natural language processing and cognitive systems operating on a corpus of medical information to determine appropriate medical code mappings for the local medical code. The natural language processing and cognitive systems may further operate on natural language text, keyword or key phrase listings, or other identifiers of concepts associated with the standardized medical codes to thereby select candidate standardized medical codes for mapping to the local medical code. Based on confidence values associated with the candidate standardized medical codes, one or more are selected and either automatically used to generate a mapping rule or presented to a SME for verification and selection before using them to generate a mapping rule.

Before beginning a more detailed discussion of the various aspects of the illustrative embodiments, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

In the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

In addition, it should be appreciated that the present description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

From the above general overview of the mechanisms of the illustrative embodiments, it is clear that the illustrative embodiments are implemented in a computing system environment and thus, the present invention may be implemented as a data processing system, a method implemented in a data processing system, and/or a computer program product that, when executed by one or more processors of one or more computing devices, causes the processor(s) to perform operations as described herein with regard to one or more of the illustrative embodiments. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As shown in the figures, and described hereafter, one or more computing devices comprising a distributed data processing system, may be specifically configured to implement a patient registry system in accordance with one or more of the illustrative embodiments. The configuring of the computing device(s) may comprise the providing of application specific hardware, firmware, or the like to facilitate the performance of the operations and generation of the outputs described herein with regard to the illustrative embodiments. The configuring of the computing device(s) may also, or alternatively, comprise the providing of software applications stored in one or more storage devices and loaded into memory of a computing device for causing one or more hardware processors of the computing device to execute the software applications that configure the processors to perform the operations and generate the outputs described herein with regard to the illustrative embodiments. Moreover, any combination of application specific hardware, firmware, software applications executed on hardware, or the like, may be used without departing from the spirit and scope of the illustrative embodiments.

It should be appreciated that once the computing device is configured in one of these ways, the computing device becomes a specialized computing device specifically configured to implement the mechanisms of one or more of the illustrative embodiments and is not a general purpose computing device. Moreover, as described hereafter, the implementation of the mechanisms of the illustrative embodiments improves the functionality of the computing device(s) and provides a useful and concrete result that facilitates creating and maintaining patient electronic medical records (EMRs) in a patient registry by collecting and combining medical information for a patient from disparate sources and standardizing the medical codes utilized in the collected and combined medical information.

As mentioned above, the mechanisms of the illustrative embodiments may be implemented in many different types of data processing systems, both stand-alone and distributed. Some illustrative embodiments implement the mechanisms described herein in a cloud computing environment. It should be understood in advance that although a detailed description on cloud computing is included herein, implementation of the teachings recited herein are not limited to a cloud computing environment. Rather, embodiments of the present invention are capable of being implemented in conjunction with any other type of computing environment now known or later developed. For convenience, the Detailed Description includes the following definitions which have been derived from the “Draft NIST Working Definition of Cloud Computing” by Peter Mell and Tim Grance, dated Oct. 7, 2009.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models. Characteristics of a cloud model are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service models of a cloud model are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment models of a cloud model are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes. A node in a cloud computing network is a computing device, including, but not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like. A cloud computing node is capable of being implemented and/or performing any of the functionality set forth hereinabove.

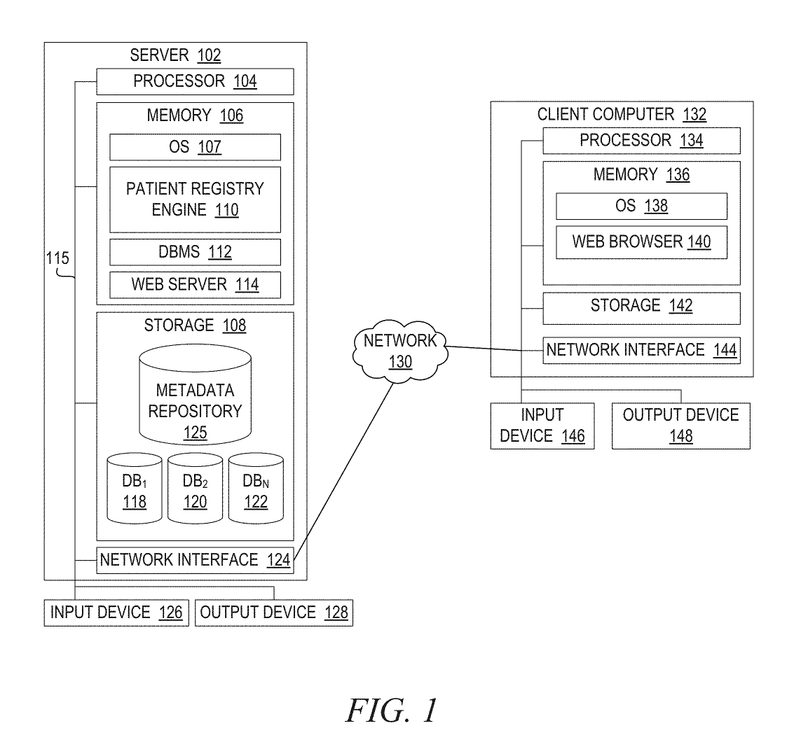

FIG. 1 is a block diagram illustrating a cloud computing system 100 for providing software as a service, where a server provides applications and stores data for multiple clients in databases according to one example embodiment of the invention. The networked system 100 includes a server 102 and a client computer 132. The server 102 and client 132 are connected to each other via a network 130, and may be connected to other computers via the network 130. In general, the network 130 may be a telecommunications network and/or a wide area network (WAN). In a particular embodiment, the network 130 is the Internet.

The server 102 generally includes a processor 104 connected via a bus 115 to a memory 106, a network interface device 124, a storage 108, an input device 126, and an output device 128. The server 102 is generally under the control of an operating system 107. Examples of operating systems include UNIX, versions of the Microsoft Windows™ operating system, and distributions of the Linux™ operating system. More generally, any operating system supporting the functions disclosed herein may be used. The processor 104 is included to be representative of a single CPU, multiple CPUs, a single CPU having multiple processing cores, and the like. Similarly, the memory 106 may be a random access memory. While the memory 106 is shown as a single identity, it should be understood that the memory 106 may comprise a plurality of modules, and that the memory 106 may exist at multiple levels, from high speed registers and caches to lower speed but larger DRAM chips. The network interface device 124 may be any type of network communications device allowing the server 102 to communicate with other computers via the network 130.

The storage 108 may be a persistent storage device. Although the storage 108 is shown as a single unit, the storage 108 may be a combination of fixed and/or removable storage devices, such as fixed disc drives, solid state drives, floppy disc drives, tape drives, removable memory cards or optical storage. The memory 106 and the storage 108 may be part of one virtual address space spanning multiple primary and secondary storage devices.

As shown, the storage 108 of the server contains a plurality of databases. In this particular drawing, four databases are shown, although any number of databases may be stored in the storage 108 of server 102. Storage 108 is shown as containing databases numbered 118, 120, and 122, each corresponding to different types of patient related data and medical code mapping rules repositories for various medical information sources. For example, the databases may include electronic medical records (EMRs) and demographic information, lifestyle information, treatment guidelines, personalized patient care plans, and the like. In addition, the databases may include one or more medical code mapping rules repositories established for one or more medical information sources, e.g., particular medical practices, particular medical labs, government organizations or programs, health insurance providers, payment providers, and the like. Storage 108 is also shown containing metadata repository 125, which stores identification information, pointers, system policies, and any other relevant information that describes the data stored in the various databases and facilitates processing and accessing the databases.

The input device 126 may be any device for providing input to the server 102. For example, a keyboard and/or a mouse may be used. The output device 128 may be any device for providing output to a user of the server 102. For example, the output device 108 may be any conventional display screen or set of speakers. Although shown separately from the input device 126, the output device 128 and input device 126 may be combined. For example, a display screen with an integrated touch-screen may be used.

As shown, the memory 106 of the server 102 includes a patient registry engine application 110 configured to provide a plurality of services to users via the network 130. As shown, the memory 106 of server 102 also contains a database management system (DBMS) 112 configured to manage a plurality of databases contained in the storage 108 of the server 102. The memory 106 of server 102 also contains a web server 114, which performs traditional web service functions, and may also provide application server functions (e.g. a J2EE application server) as runtime environments for different applications, such as the patient registry engine application 110.

As shown, client computer 132 contains a processor 134, memory 136, operating system 138, storage 142, network interface 144, input device 146, and output device 148, according to an embodiment of the invention. The description and functionality of these components is the same as the equivalent components described in reference to server 102. As shown, the memory 136 of client computer 132 also contains web browser 140, which is used to access services provided by server 102 in some embodiments.

The particular description in FIG. 1 is for illustrative purposes only and it should be understood that the invention is not limited to specific described embodiments, and any combination is contemplated to implement and practice the invention. Although FIG. 1 depicts a single server 102, embodiments of the invention contemplate any number of servers for providing the services and functionality described herein. Furthermore, although depicted together in server 102 in FIG. 1, the services and functions of the patient registry engine application 110 may be housed in separate physical servers, or separate virtual servers within the same server. The patient registry engine application 110, in some embodiments, may be deployed in multiple instances in a computing cluster. The modules performing their respective functions for the patient registry engine application 110 may be housed in the same server, on different servers, or any combination thereof. The items in storage, such as metadata repository 125, databases 118, 120, and 122, may also be stored in the same server, on different servers, or in any combination thereof, and may also reside on the same or different servers as the application modules.

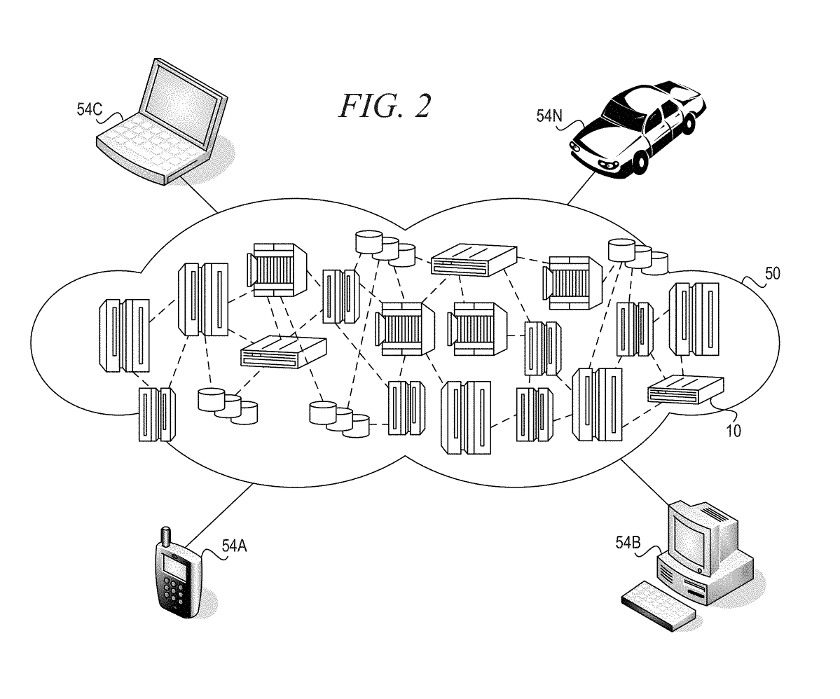

Referring now to FIG. 2, another perspective of an illustrative cloud computing environment 250 is depicted. As shown, cloud computing environment 250 comprises one or more cloud computing nodes 210, which may include servers such as server 102 in FIG. 1, with which local computing devices used by cloud consumers, such as, for example, personal digital assistant (PDA) or cellular telephone 254A, desktop computer 254B, laptop computer 254D, and/or automobile computer system 254N may communicate. Nodes 210 may communicate with one another. A computing node 210 may have the same attributes as server 102 and client computer 132, each of which may be computing nodes 210 in a cloud computing environment. They may be grouped (not shown) physically or virtually, in one or more networks, such as Private, Community, Public, or Hybrid clouds as described hereinabove, or a combination thereof. This allows cloud computing environment 250 to offer infrastructure, platforms and/or software as services for which a cloud consumer does not need to maintain resources on a local computing device. It is understood that the types of computing devices 254A-N shown in FIG. 2 are intended to be illustrative only and that computing nodes 210 and cloud computing environment 250 can communicate with any type of computerized device over any type of network and/or network addressable connection (e.g., using a web browser).

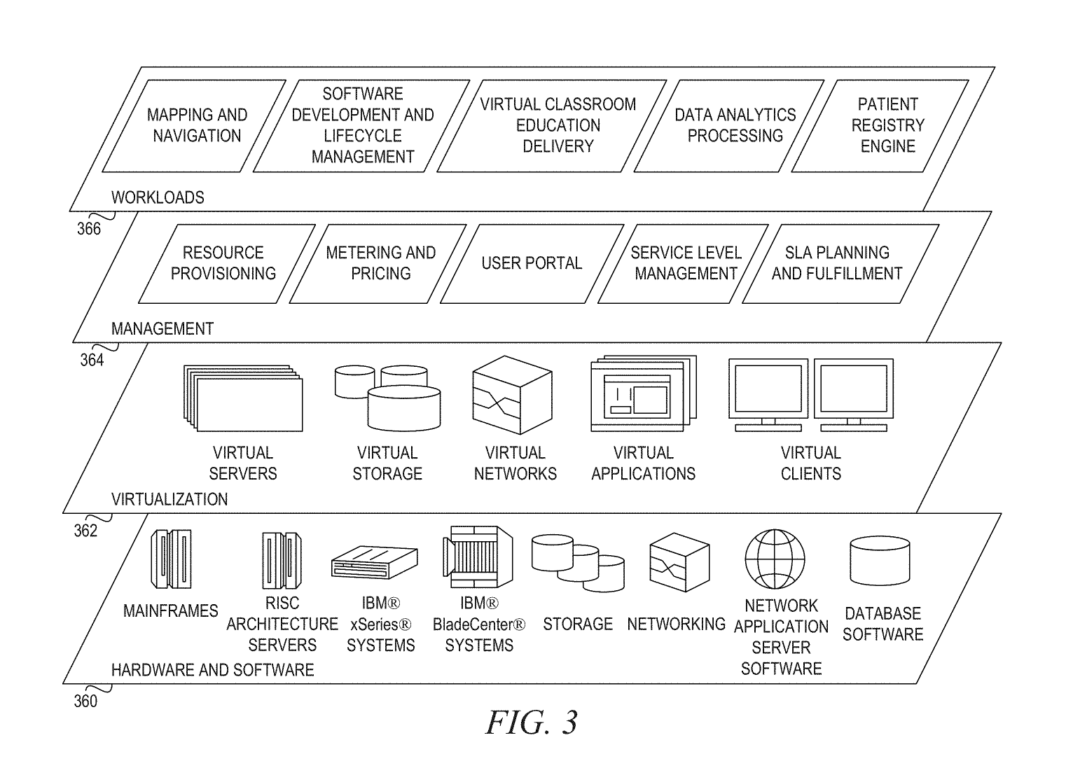

Referring now to FIG. 3, a set of functional abstraction layers provided by cloud computing environment 250 (FIG. 2) is shown. It should be understood in advance that the components, layers, and functions shown in FIG. 3 are intended to be illustrative only and embodiments of the invention are not limited thereto. As depicted, the following layers and corresponding functions are provided.

The hardware and software layer 360 includes hardware and software components. Examples of hardware components include mainframes, in one example IBM™ zSeries™ systems; RISC (Reduced Instruction Set Computer) architecture based servers, in one example IBM pSeries™ systems; IBM xSeries™ systems; IBM BladeCenter™ systems; storage devices; networks and networking components. Examples of software components include network application server software, in one example IBM Web Sphere™ application server software; and database software, in one example IBM DB2™ database software. (IBM, zSeries, pSeries, xSeries, BladeCenter, WebSphere, and DB2 are trademarks of International Business Machines Corporation registered in many jurisdictions worldwide.).

The virtualization layer 362 provides an abstraction layer from which the following examples of virtual entities may be provided: virtual servers; virtual storage; virtual networks, including virtual private networks; virtual applications and operating systems; and virtual clients. In one example, management layer 364 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 366 provides examples of functionality for which the cloud computing environment may be utilized. Examples of workloads and functions which may be provided from this layer include: mapping and navigation; software development and lifecycle management; virtual classroom education delivery; data analytics processing; transaction processing; and, in accordance with the mechanisms of the illustrative embodiments, a patient registry engine functionality.

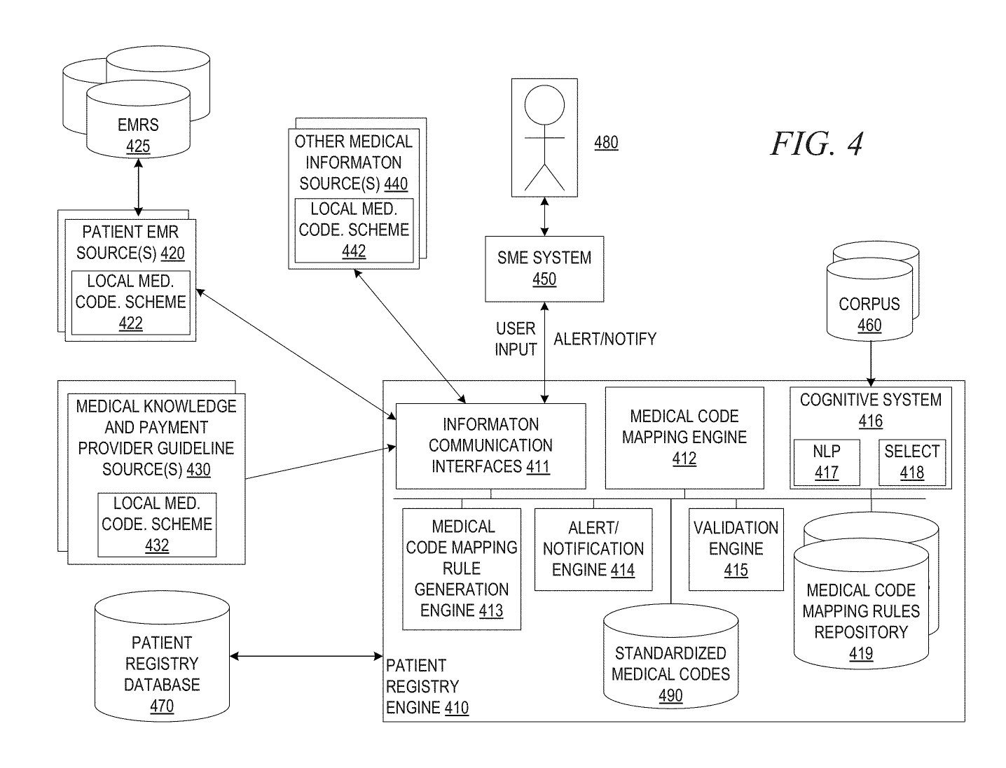

As discussed above, the illustrative embodiments provide a patient registry engine that comprises medical code mapping mechanisms, and which may be implemented in various types of data processing systems. FIG. 4 is an example block diagram illustrating the primary operational elements of such a patient registry engine having medical code mapping logic in accordance with one illustrative embodiment. The operational elements shown in FIG. 4 may be implemented as specialized hardware elements, software executing on hardware elements, or any combination of specialized hardware elements and software executing on hardware elements without departing from the spirit and scope of the present invention.

As shown in FIG. 4, the primary operational elements comprise a patient registry engine 410, one or more patient electronic medical record (EMR) sources 420, one or more medical knowledge and payment provider guideline sources 430, other medical information source(s) 440, a SME system 450 for communicating with a SME 480, a corpus of medical information 460, a patient communication system 460, and a patient registry database 470. It should be appreciated that while the elements 410-470 are illustrated as separate elements in FIG. 4, the illustrative embodiments are not limited to such. Rather, many of the elements shown in FIG. 4 may be integrated with one another without departing from the spirit and scope of the illustrative embodiments. For example, in some illustrative embodiments, the patient EMR sources 420, SME system 450, patient registry engine 410, and patient registry database 470 may all be integrated with one another so as to provide a single suite of tools that may be executed or otherwise implemented using one or more data processing systems. This single suite of tools may be deployed at a single medical practice location and corresponding data processing systems, in a centralized or distributed fashion in association with multiple medical practices and locations, or any other suitable deployment configuration.

The patient registry engine 410 provides the various engines and logic for ingesting and processing patient electronic medical records (EMRs), medical knowledge and payment provider guidelines, and other medical information, to determine instances of local medical codes and map those instances of local medical codes to standardized medical codes, among other functionality. The patient registry engine 410 operates to collect and compile for each patient, medical information from patient EMR sources 420 and other medical information sources 440. The patient registry engine 410 utilizes the medical knowledge and payment provider guideline source(s) 430 to assist with the ingestion and processing of this medical information for the patient. The collected and complied medical information for the patient is stored in one or more electronic health records (EHRs) in the patient registry database 470.

The patient's EMRs 425 are provided by one or more patient EMR sources 420 to the patient registry engine 410 via the information communication interfaces 411 while other medical information may be provided from other medical information sources 440 via the information communication interfaces 411. The information communication interfaces 411 provides one or more data communication interfaces through which patient data, medical information, and the like, may be obtained from various patient EMR data sources 420 and other medical information sources 440, as well as medical knowledge and payment provider guideline sources 430. Moreover, the interfaces 411 comprise interfaces for interfacing with a SME system 450 to perform validations for medical code mappings, provide alerts/notifications of candidate medical code mappings, and receive input from the SME 480 for validating a medical code mapping and provide an alternative medical code mapping.

The EMR data sources 420 may comprise various sources of electronic medical records including individual doctor medical practice systems, hospital computing systems, medical lab computing systems, personal patient devices for monitoring health of the patient, dietary information, and/or activity information of the patient, or any other source of medical data that represents a particular patient's current and historical medical condition. The other medical information source(s) 440 represent other possible sources of medical information about a particular patient, e.g., gym records that may indicate patient body-fat ratios, which may supplement or augment the patient EMRs 425 from other more medical service oriented sources. That is, the patient EMR sources 420 are considered to represent traditional sources of medical information about patients such as hospital computing systems, doctor office computing systems, medical lab systems, and the like. The other medical information source(s) 440 represent non-traditional sources of medical information, such as gyms, alternative therapy service providers, and the like.

In accordance with the illustrative embodiments, the patient EMRs represent patient medical history information that is ingested and processed by the patient registry engine 410. As part of this processing, the patient registry engine 410 determines whether any instances of local medical codes are present in the EMRs or other medical information. The identification of local medical codes present in the EMRs or other medical information may be performed using pattern matching, natural language processing, and/or cognitive processing of the EMRs or other medical information (hereafter referred to as “patient information” collectively). The patient information may be passed through the cognitive system 416 to extract instances of local medical codes which are then used as a basis for performing a lookup operation to find a medical code mapping rule that maps the local medical code to a standardized medical code. Based on the lookup operation, the mapping is performed and the mapped instances of medical codes are added to the patient information either in addition to, or in replacement of, the original local medical code instances when storing the patient information to the patient registry database 470.

The medical knowledge and payment provider guideline sources 430 provide information to the patient registry engine 410 indicating general medical knowledge regarding various medical maladies from established medical knowledge bases, information regarding policies of various payment providers as specified in payment provider guidelines, and of particular importance to the mechanisms of the illustrative embodiments, medical codes recognized by the particular individual payment providers, health insurance companies, government agencies and programs, and the like. This information may be used by the patient registry engine 410 to identify instances of local medical codes in patient information, provide a standardized medical coding scheme, such as a standardized organization or government mandated medical coding scheme, or the like.

The SME system 450 may be any computing system, such as a workstation, portable computer, or the like, through which a human SME 480 may receive communications from the patient registry engine 410 and provide input to respond to such communications. For example, the SME system 450 may be a client workstation with a standard computing system hardware configuration, but which is configured by software to provide an interface with the patient registry engine 410 through which the SME 480 receives such communications and provides responses. The SME system 450 interfaces with the patient registry engine 410 via the information communication interfaces 411. It should be appreciated that, while not explicitly shown in FIG. 4, there may be one or more wired and/or wireless data networks connecting elements of FIG. 4 and that the information communication interfaces 411 may provide an interface to these data network(s) so as to communicate with sources 420, 430, and 440 as well as SME system 450.

The corpus 460 represents a collection of electronic documents representing medical knowledge which is used by the cognitive system 416 to perform cognitive operations on patient information to identify the underlying meaning of local medical code instances present in the patient information. The corpus 460 may comprise electronic versions of medical journals, websites, published papers, reference materials such as drug reference manuals, and the like. Although shown as separate in FIG. 4 for purposes of illustration, corpus 460 may also comprise the EMRs 425, other medical information, and medical knowledge and payment provider guideline information form the sources 420-440 in some embodiments. The cognitive system 416 ingests the corpus 460 and uses the key features extracted from the various documents of the corpus 460 as evidence information for identifying candidate medical code mapping rules based on correlations with key features extracted from the patient information, as described hereafter.

As shown in FIG. 4, the patient registry engine 410 comprises, in addition to the information communication interfaces 411 discussed above, a medical code mapping engine 412, a medical code mapping rule generation engine 413, an alert/notification engine 414, a validation engine 415, a cognitive system 416 having natural language processing (NLP) logic 417 and medical code mapping rule selection logic 418, and one or more medical code mapping rules repositories 419. The medical code mapping engine 412 provides the logic for identifying a medical code mapping rules repository 419 corresponding to the source of patient information and performing a lookup operation within the repository 419 to determine if a valid and non-expired medical code mapping rule exists for an instance of a local medical code in the patient information received from that source. The medical code mapping engine 412 then either performs the mapping if the mapping exists, or interacts with other elements of the patient registry engine 410, as discussed hereafter, to generate a medical code mapping rule for the local medical code instance and add it to the repository 419 as well as utilize it to perform the mapping.

The medical code mapping rule generation engine 413 provides the logic for actually generating medical code mapping rules for adding to and/or replacing medical code mapping rules in the repositories 419. The medical code mapping rule generation engine 413 may generate these medical code mapping rules based on results generated by the cognitive system 416, provided in responses from the SME 480 via the SME system 450 and interfaces 411, or the like. The medical code mapping rules generated by the medical code mapping rule generation engine 413 essentially state that an instance of a local mapping code is equivalent to one or more standardized medical codes according to a standardized medical coding scheme employed by the patient registry engine 410, e.g., local medical code A=standardized medical code Z.

The alert/notification engine 414 generates alerts/notifications in response to a medical code mapping rule not being present in the medical code mapping rules repository 419 for the source or in response to a validation of a medical code mapping rule in the repository being determined to be potentially invalid. The alerts/notifications are sent to the SME system 450 for viewing by the SME 480. The alerts/notifications may comprise information indicating either the potential medical code mapping to be added/replaced in the medical code mapping rules repository 419, the medical code mapping rule that was determined to be potentially invalid, and provides user interface elements for receiving input from the SME 480 via the SME system 450 to obtain commands as to how to resolve the issue that gave rise to the alert/notification, e.g., validate the mapping, invalidate the mapping, provide an alternative mapping of medical codes, etc.

The validation engine 415 provides the logic for actually performing a validation operation on the medical code mapping rules in the repositories 419. The validation engine 415 may periodically analyze the timestamps, expiration times, etc., associated with the medical code mapping rules in the repositories 419 and determine which, if any, have expired and need to be re-validated. The validation engine 415 then performs the validation, as described hereafter, and updates the medical code mapping rules repositories to mark the corresponding medical code mapping rules as valid/invalid and interfaces with the alert/notification engine 414 to facilitate obtain SME 480 feedback as to the validity of the mapping rules.

The cognitive system 416 comprises logic for performing cognitive operations on natural language and structured patient information as well as corpus 460 documentation to facilitate determining the meaning of local medical codes in patient information. In one illustrative embodiment, the cognitive system 416 is the IBM Watson™ cognitive system available from International Business Machines Corporation of Armonk, N.Y. The cognitive system 416 ingests natural language content, extracts key features from the natural language content, annotates the natural language content based on the extracted key features, and uses the ingested natural language content to perform cognitive operations such as processing natural language questions and selecting answers to return in response to the natural language questions, performing natural language searches of content and selecting results to be returned, or the like. With regard to the illustrative embodiments, the cognitive system 416 is configured to analyze the natural language content of patient information to extract key features. These key features are then used as a basis for processing one or more queries against the corpus 460 to identify evidential natural language passages corresponding to these key features. The key features of these natural language passages are then used as a basis of correlation with natural language and/or structured descriptions of standardized medical codes in the standardized medical code database 490. Based on the correlation, measures of confidence that the local medical code in the patient information correlates with various ones of the standardized medical codes 490. The confidence measures are then used to select a standardized medical code or codes for mapping to the local medical code in the patient information. If the confidence measure is sufficiently high, then the mapping may be done automatically. If the confidence measure is not sufficiently high, then the alert/notification engine 414 may be used to solicit SME 480 feedback as to whether the candidate standardized medical code(s) actually do correspond to the local medical code.

With regard to the operation of the patient registry engine 410, when patient information for a patient is received from a source, such as patient EMR source 420, other medical information source 440, or the like, via the interfaces 411, the medical code mapping rules repository 419 for that source is identified by the medical code mapping engine 412 and searched with regard to any instances of local medical codes found in the patient information. That is, the medical code mapping engine 412 analyzes the patient information, possibly employing the cognitive system 416 and its natural language processing logic 417, to identify instances of local medical codes present in the patient information. Then, for each local medical code instance, the source's mapping repository 419 is consulted to determine if there is an existing medical code mapping rule that maps the local medical code instance to one or more standardized medical codes 490. If the mapping exists, then the instance of the local medical code is replaced with the one or more standardized medical codes 490. Alternatively, rather than replacing the local medical code entirely, annotations or other metadata may be added with pointers or other structures to identify the standardized medical code(s) as being associated with the instance of the local medical code in the patient information. This modified patient information is then added to other patient information for the patient in a corresponding set of patient electronic health records (EHRs) in the patient registry database 470.

If such a mapping does not exist, or the mapping has potentially expired as discussed hereafter, then a natural language processing operation is employed using the cognitive system 416 to analyze the natural language context of the local medical code as well as other descriptive text from a corpus 460 of other documents from the same source of the patient information and/or a plurality of other sources of medical information. As noted above, this natural language processing operation may comprise extracting key features, such as key words, key phrases, and the like, from the natural language content of the patient information and finding evidential support in the corpus 460 as to the meaning, or concepts, that are referenced in the natural language content. In some cases, the identification of key features may include various other types of lexical, semantic, and syntactic analysis and feature extraction as well. In some cases, synonym and antonym analysis is performed to identify synonyms and antonyms to the key words and phrases. Any known or later developed natural language processing and cognitive system type of analysis may be performed as part of the operation for identifying key features of the patient information and/or corpus 460.

This key feature information may then be used as a basis to search for standardized medical codes based on descriptions of these standardized medical codes in the standardized medical codes database 490. Based on the standardized medical codes having key features that match or are similar to the key features extracted from the patient information, scoring of these standardized medical codes is performed based on the finding of evidence in the corpus 460 to support the standardized medical code as being a correct medical code for the mapping to the local medical code. For example, instances of key features in the description of the standardized medical code may be evaluated in documentary evidence supporting the key features extracted from the patient information to determine a likelihood that the standardized medical code is a good mapping for the local medical code instance. Of course the entire corpus 460 may also be analyzed in this manner to determine evidence in support of this mapping. From the evidential support, a confidence measure is calculated for the candidate mapping of the local medical code instance to the standardized medical code(s).

The selection logic 418 of the cognitive system may then analyze the candidate mappings of the local medical code instance to various standardized medical codes and select a mapping having a highest confidence measure. The confidence measure may then be compared to one or more threshold values to determine whether to automatically implement the mapping, request SME feedback regarding the mapping, or discard the mapping and alert the SME of the failure to recognize the local medical code in the patient information. For example, if the confidence level of the mapping is equal to or greater than a first threshold value, the mapping may be performed automatically and the corresponding mapping rule is stored in the mapping repository 419 for the source so that it may be used again in the future. The medical code mapping rule generation engine 413 may be employed to perform such operations of generating and storing the medical code mapping rule and may also set the timestamp or expiration time for the mapping rule in the entry in the repository 419.

If the confidence level is equal to or greater than the first threshold, then a determination may be made as to whether the confidence level is equal to or greater than a second threshold. If so, then human SME 480 confirmation of the mapping may be solicited by providing a suggestion to the SME as to the mapping in an alert/notification message sent by the alert/notification engine 414 to the SME system 450 specifying the candidate mapping, the confidence measure, the local medical code, and a portion of the natural language content that forms the context of the local medical code. The alert/notification may further include user interface elements that the SME 480 may used to validate the mapping, invalidate or discard the mapping, and/or provide the SME's own alternate mapping to be added to the repository. If the SME confirms or validates the mapping, then it is added to the mapping repository 419 for the source via the rule generation performed by the medical code mapping rule generation engine 413. If the SME provides an alternative mapping, then the alternative mapping is provided to the medical code mapping rule generation engine 413 which then generates the corresponding mapping rule that is added to the mapping repository 419 for the source. If the SME rejects the mapping, and does not provide an alternative mapping, then no modification of the mapping repository is performed.

Moreover, if the confidence measure of the mapping is not sufficiently high enough to equal or exceed the second threshold value, then no modification to the mapping repository is performed and no mapping of the local medical code is performed. Instead, an alert may be generated and sent to the SME 480 via the SME system 450 indicating the inability to map the local medical code. The SME 480 may then take actions to rectify the problem by adding mapping rules to the corresponding repository, updating the standardized medical codes 490 to include a new standardized medical code, or the like.

As noted above, these mechanisms may also be used to validate existing mappings in the mapping repository 419 for the source as well. That is, the validation engine 415 may perform a periodic validation operation based on a triggering event. For example, the triggering event may be the expiration of a mapping rule in the mapping repository 419 as determined from a periodic or triggered analysis of the medical code mapping rules in the repository. That is, each mapping rule may have a timestamp or expiration time attribute which may be compared to current timestamp information to determine if the corresponding mapping rule has expired. Such expiration ensures that the most up-to-date medical codes and corresponding mappings are being utilized since such medical coding schemes may change over time. If the mapping rule has expired, then a validation operation may be triggered by the validation engine 415. Other triggering events may include a user specifically requesting that mapping rules be validate, an error event occurring that indicates that a validation of the mapping rules should be performed, or the like.

In one illustrative embodiment, the validation engine 415 may analyze all of the timestamps of all of the medical code mapping rules repositories 419 on a scheduled basis. In another illustrative embodiment, the validation engine 415 may trigger the validation operation in response to a matching of a local medical code to a rule in the repository whose timestamp/expiration time has expired and the validation is then performed prior to performing the mapping of the local medical code to the standardized medical code based on the expired rule.

In order to perform the validation, the above analysis performed in the case that no mapping exists in the mapping repository 419 for the source is performed regardless of whether there is a mapping present in the mapping repository 419, i.e. it is assumed a priori that there is no mapping in the repository 419, however the mapping is retrieved for later comparison. In this way, a candidate mapping rule of the local medical code to one or more standardized medical codes is generated in the manner previously described using the cognitive system 416. This candidate mapping rule may then be compared, by the validation engine 415, to the actual existing mapping rule in the mapping repository 419 to see if there is a match. If there is a match, i.e. the same one or more standardized medical codes are indicated by both the existing mapping rule and the candidate mapping rule, then the existing mapping rule is validated in the mapping repository 419 by the validation engine 415 and its corresponding timestamp/expiration time is updated to reflect the validation time, i.e. the validation timestamp/expiration time is reset to correlate to a time in the future. If not, then the existing mapping rule may need to be re-evaluated by a human SME 480. A corresponding notification may be sent by the alert/notification engine 414 to the human SME 480 via the SME system 450 to request that the SME 480 either manually validate the existing mapping rule by responding to the notification electronically, provide an alternative mapping rule for the local medical code which is then used to replace the existing mapping rule, or invalidate the existing mapping rule by deleting it from the mapping repository or otherwise marking it as invalid, in which case it will be considered to be essentially not present in the mapping repository 419 and a candidate for overwriting at a later time.

Thus, the illustrative embodiments provide mechanisms for mapping local medical codes in patient information from various sources to a standardized medical coding scheme. The mechanisms of the illustrative embodiments may utilize natural language processing and cognitive systems operating on a corpus of medical information to determine appropriate medical code mappings for the local medical code. Moreover, validation of existing medical code mappings is made possible by the mechanisms of the illustrative embodiments.

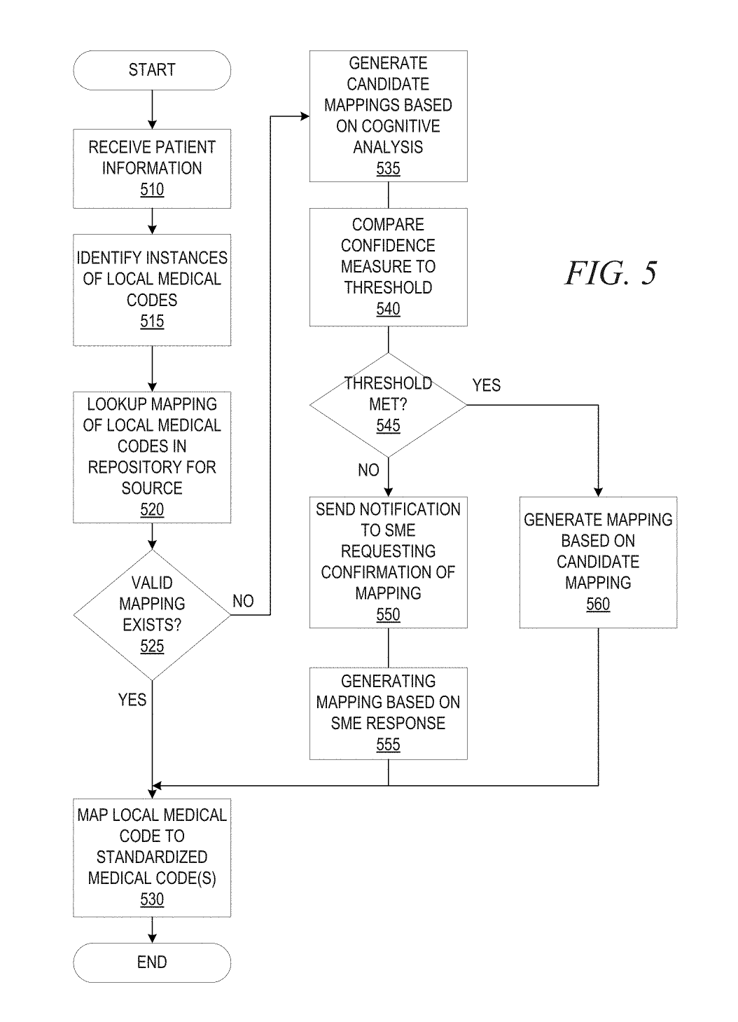

FIG. 5 is a flowchart outlining an example operation for performing medical code mapping in accordance with one illustrative embodiment. As shown in FIG. 5, the operation starts by receiving patient information from a patient information source (step 510). The patient information is analyzed to identify instances of local medical codes within the patient information (step 515). A lookup operation is performed in a corresponding medical code mapping rules repository for the source to determine if a mapping for the local medical code already exists and is both valid and not expired (step 520). If there is a valid, non-expired mapping in the repository (step 525), then the local medical code is mapped to the corresponding standardized medical code(s) and the modified patient information with the mapping having been done is stored in the patient registry database (step 530).

If a valid, non-expired mapping does not exist in the repository (step 525), then a candidate mapping is generated using a cognitive system analysis of the patient information (step 535). The candidate mappings that are generated are used as a basis for selection of a candidate mapping for further evaluation which involves comparing the confidence measure calculated for the selected candidate mapping to a threshold confidence value (step 540). It should be noted that the example depicted in FIG. 5 uses a single threshold, however as discussed above other embodiments may make use of multiple threshold values and comparison to each may be performed until one is met.

If the confidence measure meets or exceeds the threshold value (step 545), then the mapping of the local medical code to the standardized medical code is generated based on the candidate mapping (step 560). Otherwise, if the confidence score is not met or exceeded (step 545), then a notification is sent to the SME requesting confirmation of candidate mapping (step 550). Based on the SME response, a mapping is generated (step 555). This may include generating the mapping based on the candidate mapping if the SME confirms the mapping or generating an alternate mapping as specified by the SME, for example. The generated mapping is stored in the repository for the source. Thereafter, the mapping is applied to the local medical code instance in the patient information (step 530) and the operation terminates.

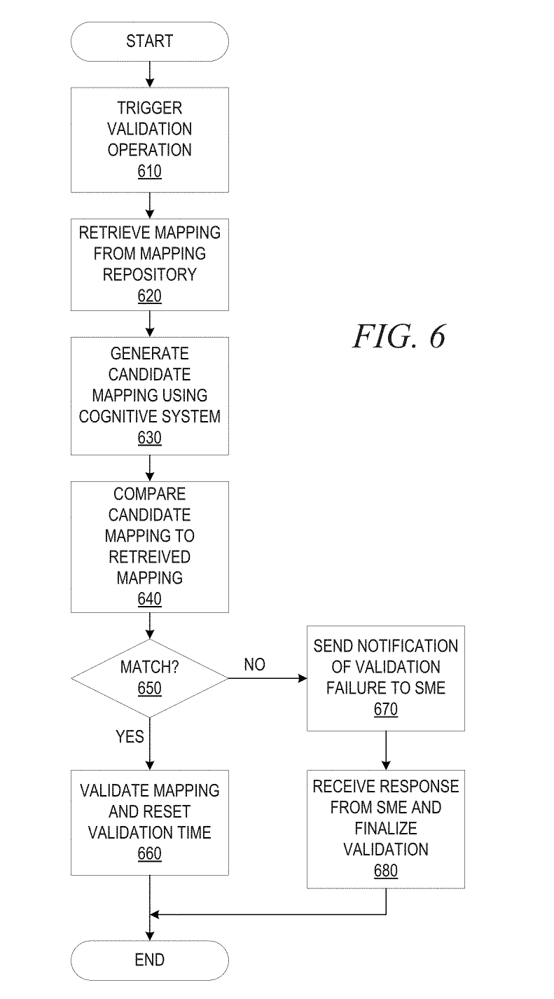

FIG. 6 is a flowchart outlining an example operation for validating an existing medical code mapping in accordance with one illustrative embodiment. As shown in FIG. 6, the operation starts by the triggering of a validation operation (step 610). The mapping rule to be validate is retrieved from the repository (step 620) and candidate mapping is generated for the local medical code specified in the retrieved mapping rule using the cognitive system (step 630). The candidate mapping rule is compared to the existing mapping rule to determine if there is a match (step 640). If there is a match, then the mapping rule is validate and the validation time in the repository is updated accordingly (step 660). If there is not a match, then a notification is sent to a SME indicating the validation failure (step 670). The SME may then respond to the notification by either validating the mapping manually, providing an alternative mapping to replace the invalid mapping, or invalidating the mapping. The validation is then finalized in accordance with the SME's response to either validate the mapping in the repository, modify the mapping in the repository, or mark the mapping as invalid (step 680). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, in a data processing system comprising a processor and a memory, for mapping local medical codes to standardized medical codes, comprising:
receiving, by the data processing system, patient information from a source, wherein the patient information comprises at least one local medical code that is local to the source and is not standardized across multiple sources of patient information;
performing, by the data processing system, cognitive natural language processing on a context of the at least one local medical code to determine a meaning of the at least one local medical code;
selecting, by the data processing system, a standardized medical code from a plurality of standardized medical codes based on the determined meaning of the at least one local medical code, wherein the plurality of standardized medical codes are common to a plurality of sources of patient information;
generating, by the data processing system, a mapping data structure that maps the at least one local medical code to the selected standardized medical code; and
processing, by the data processing system, the patient information from the source based on the mapping data structure.

2. The method of claim 1, wherein selecting the standardized medical code from the plurality of standardized medical codes comprises:
comparing the determined meaning of the at least one local medical code to a plurality of pre-defined descriptions of a plurality of standardized medical codes; and
selecting the standardized medical code based on results of the comparison.

3. The method of claim 1, wherein the plurality of standardized medical codes correspond to an established government health care program or a health insurance provider program.

4. The method of claim 1, wherein the mapping data structure is a mapping data structure that comprises one or more medical code mapping rules for mapping the at least one local medical code associated with the source to one or more standardized medical codes for one or more standardized medical coding schemes, and wherein the mapping data structure is stored in a medical code mapping rules repository for application to other patient information for other patients.

5. The method of claim 1, further comprising, in response to receiving the patient information from the source:
analyzing the patient information to identify an instance of a local medical code, of the at least one local medical code, within the patient information; and
performing a lookup operation, in a medical code mapping rules repository, of the instance of the local medical code to determine whether a medical code mapping rule exists for the instance of the local medical code, wherein the cognitive natural language processing, selecting, and generating operations are performed in response to a medical code mapping rule not existing in the medical code mapping rules repository for the instance of the local medical code.

6. The method of claim 5, further comprising:
in response to the lookup operation identifying a medical code mapping rule existing for the instance of the local medical code, retrieving a timestamp associated with the medical code mapping rule and comparing the timestamp to a current time; and
in response to the comparison of the timestamp to the current time indicating that the medical code mapping rule has expired, performing the cognitive natural language processing, selecting, and generating operations.

7. The method of claim 2, wherein comparing the determined meaning of the at least one local medical code to the plurality of pre-defined descriptions of a plurality of standardized medical codes further comprises calculating a confidence score for each of the pre-defined descriptions in the plurality of pre-defined descriptions indicating a confidence that the determined meaning of the at least one local medical code matches the pre-defined description.

8. The method of claim 7, wherein selecting the standardized medical code from the plurality of standardized medical codes based on results of the comparison further comprises:
comparing each confidence score for each of the pre-defined descriptions to at least one threshold; and
selecting a standardized medical code corresponding to a pre-defined description having a highest confidence score equal to or greater than the at least one threshold.

9. The method of claim 8, wherein in response to none of the confidence scores for the pre-defined descriptions equaling or exceeding the at least one threshold, sending a notification to a user requesting user input to indicate a mapping of the at least one local medical code to a standardized medical code.

10. The method of claim 1, wherein the patient information is received by a patient registry engine that receives patient information from a plurality of different sources of patient information, and wherein at least two sources of patient information utilize different local medical coding schemes having different local medical codes.

11. A computer program product comprising a computer readable storage medium having a computer readable program stored therein, wherein the computer readable program, when executed on a computing device, causes the computing device to:
receive patient information from a source, wherein the patient information comprises at least one local medical code that is local to the source and is not standardized across multiple sources of patient information;
perform cognitive natural language processing on a context of the at least one local medical code to determine a meaning of the at least one local medical code;
select a standardized medical code from a plurality of standardized medical codes based on the determined meaning of the at least one local medical code, wherein the plurality of standardized medical codes are common to a plurality of sources of patient information;
generate a mapping data structure that maps the at least one local medical code to the selected standardized medical code; and
process the patient information from the source based on the mapping data structure.

12. The computer program product of claim 11, wherein the computer readable program further causes the computing device to select the standardized medical code from the plurality of standardized medical codes at least by:
comparing the determined meaning of the at least one local medical code to a plurality of pre-defined descriptions of a plurality of standardized medical codes;
and selecting the standardized medical code based on results of the comparison.

13. The computer program product of claim 11, wherein the plurality of standardized medical codes correspond to an established government health care program or a health insurance provider program.

14. The computer program product of claim 11, wherein the mapping data structure is a mapping data structure that comprises one or more medical code mapping rules for mapping the at least one local medical code associated with the source to one or more standardized medical codes for one or more standardized medical coding schemes, and wherein the mapping data structure is stored in a medical code mapping rules repository for application to other patient information for other patients.

15. The computer program product of claim 11, wherein, in response to receiving the patient information from the source, the computer readable program further causes the computing device to:
analyze the patient information to identify an instance of a local medical code, of the at least one local medical code, within the patient information; and
perform a lookup operation, in a medical code mapping rules repository, of the instance of the local medical code to determine whether a medical code mapping rule exists for the instance of the local medical code, wherein the cognitive natural language processing, selecting, and generating operations are performed in response to a medical code mapping rule not existing in the medical code mapping rules repository for the instance of the local medical code.

16. The computer program product of claim 15, wherein the computer readable program further causes the computing device to:
in response to the lookup operation identifying a medical code mapping rule existing for the instance of the local medical code, retrieve a timestamp associated with the medical code mapping rule and comparing the timestamp to a current time; and
in response to the comparison of the timestamp to the current time indicating that the medical code mapping rule has expired, perform the cognitive natural language processing, selecting, and generating operations.

17. The computer program product of claim 12, wherein comparing the determined meaning of the at least one local medical code to the plurality of pre-defined descriptions of a plurality of standardized medical codes further comprises calculating a confidence score for each of the pre-defined descriptions in the plurality of pre-defined descriptions indicating a confidence that the determined meaning of the at least one local medical code matches the pre-defined description.

18. The computer program product of claim 17, wherein selecting the standardized medical code from the plurality of standardized medical codes based on results of the comparison further comprises:
comparing each confidence score for each of the pre-defined descriptions to at least one threshold; and
selecting a standardized medical code corresponding to a pre-defined description having a highest confidence score equal to or greater than the at least one threshold.

19. The computer program product of claim 18, wherein in response to none of the confidence scores for the pre-defined descriptions equaling or exceeding the at least one threshold, sending a notification to a user requesting user input to indicate a mapping of the at least one local medical code to a standardized medical code.

20. An apparatus comprising:
a processor; and
a memory coupled to the processor, wherein the memory comprises instructions which, when executed by the processor, cause the processor to:
receive patient information from a source, wherein the patient information comprises at least one local medical code that is local to the source and is not standardized across multiple sources of patient information;
perform cognitive natural language processing on a context of the at least one local medical code to determine a meaning of the at least one local medical code;
select a standardized medical code from a plurality of standardized medical codes based on the determined meaning of the at least one local medical code, wherein the plurality of standardized medical codes are common to a plurality of sources of patient information;
generate a mapping data structure that maps the at least one local medical code to the selected standardized medical code; and
process the patient information from the source based on the mapping data structure.
